(19) United States
(12) Patent Application Publication
(10) Pub. No.: US 2007/0196200 A1
(43) Pub. Date: Aug. 23, 2007

(54) Remotely positionable control system for a container hoist

(76) Inventors: Nate Martindale, Star City, IN (US); John Downing, Winamac, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/356,533

(22) Filed: Feb. 17, 2006

(51) Int. Cl. B60P 1/04

(52) U.S. Cl. 414/469

(57) ABSTRACT

A remotely positionable control system for use with a container hoist vehicle having a main frame and container manipulating elements includes an articulating support assembly having a first arm connectable to a hoist vehicle and a second arm movably connected to the first arm to move between a storage rest position and an extended use position, each of the first and second arms having inboard and outboard ends; a control console mounted to the outboard end of the second arm and having at least one user control element; signal transfer means for operationally connecting the at least one user control element with the container manipulating elements; and, a pivot control apparatus for releasably holding the second arm in at least one of the storage rest position and the extended use position.

### FIELD OF THE INVENTION

The present invention relates to container hoists, and more specifically, to a remotely positionable control system for operating a vehicle mounted container hoist.

### BACKGROUND OF THE INVENTION

Containers for waste, bulk goods and the like are typically transported and dumped by vehicle-mounted hoists. The hoists lift or otherwise position a container onto the vehicle main frame, after which the container is transported, dumped and/or offloaded. These hoists employ a variety of mechanisms to achieve such container manipulation, including pivoting hoist frames, sliding frames, winches, cables, hooks and/or ramps. Controls for these and other hoist mechanisms are typically located somewhere along the hoist or vehicle frame or in the vehicle cab. It is desired to provide an improved control system.

### SUMMARY OF THE INVENTION

Generally speaking, a container hoist for loading, transporting, dumping and offloading containers is provided with a control system that moves between a retracted storage and transport position and an extended, use position, away from the vehicle.

A remotely positionable control system for use with a container hoist vehicle having a main frame and container manipulating elements includes an articulating support assembly having a first arm connectable to a hoist vehicle and a second arm movably connected to the first arm to move between a storage rest position and an extended use position, each of the first and second arms having inboard and outboard ends; a control console mounted to the outboard end of the second arm and having at least one user control element; signal transfer means for operationally connecting the at least one user control element with the container manipulating elements; and, a pivot control apparatus for releasably holding the second arm in at least one of the storage rest position and the extended use position.

It is an object of the present invention to provide an improved control system for a container hoist.

Other objects and advantages will become apparent from the following description of the preferred embodiment of the invention.

### BRIEF DESCRIPTION OF THE DRAWINGS

FIG. 1 is a perspective view of a remotely positionable control system 10 mounted to a container hoist 11 in accordance with the present invention, showing control system 10 in the use position 90, and with a portion of box enclosure 30 cut away for clarity.

FIG. 2 is a side view of the control system 10 of FIG. 1, and showing control system 10 in the forward storage rest position 89.

FIG. 3 is a perspective view of lower post 35 of control system 10 of FIG. 2.

FIG. 4 is a top view of lower post 35 of FIG. 3.

FIG. 5 is a side, perspective view of pivot control apparatus 28 of FIG. 1 and with control system 10 in an intermediate position between the use position 90 and the forward storage rest position 89.

FIG. 7 is a front view of an indexing assembly 102 and locking assembly 103 in accordance with another embodiment of the present invention.

FIG. 8 is an exploded, side view of the indexing assembly 102 and locking assembly 103 of FIG. 7.

FIG. 9 is an exploded, side view of a combined indexing and locking assembly 129 in accordance with another embodiment of the present invention.

FIG. 10 is a side, elevational view of a control system 150 in accordance with another embodiment of the present invention.

### DESCRIPTION OF THE PREFERRED EMBODIMENT

For the purposes of promoting an understanding of the principles of the invention, reference will now be made to the embodiments illustrated herein and specific language will be used to describe the same. It will nevertheless be understood that no limitation of the scope of the invention is thereby intended. Any alterations and further modifications in the described processes, systems or devices, and any further applications of the principles of the invention as described herein, are contemplated as would normally occur to one skilled in the art to which the invention relates.

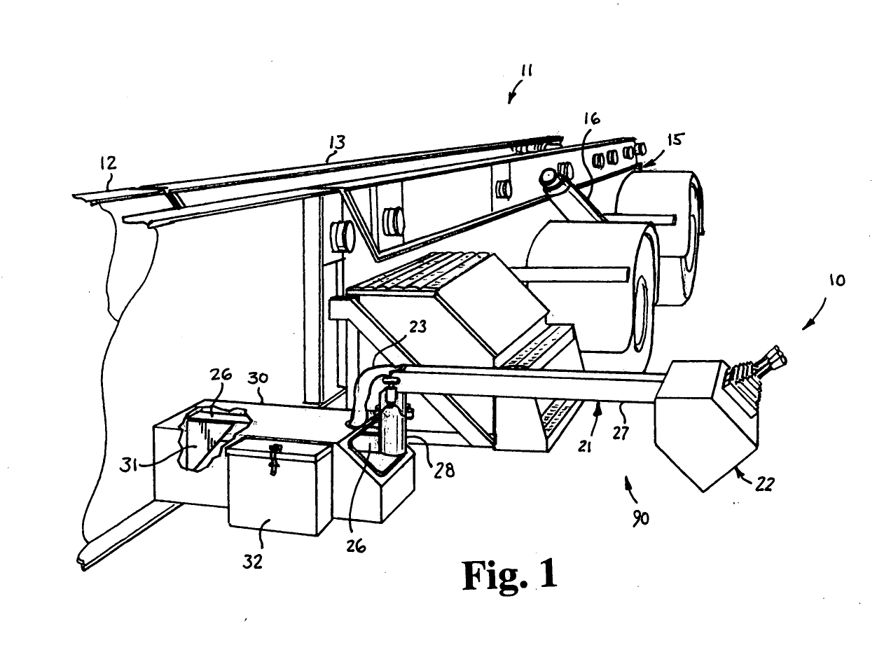

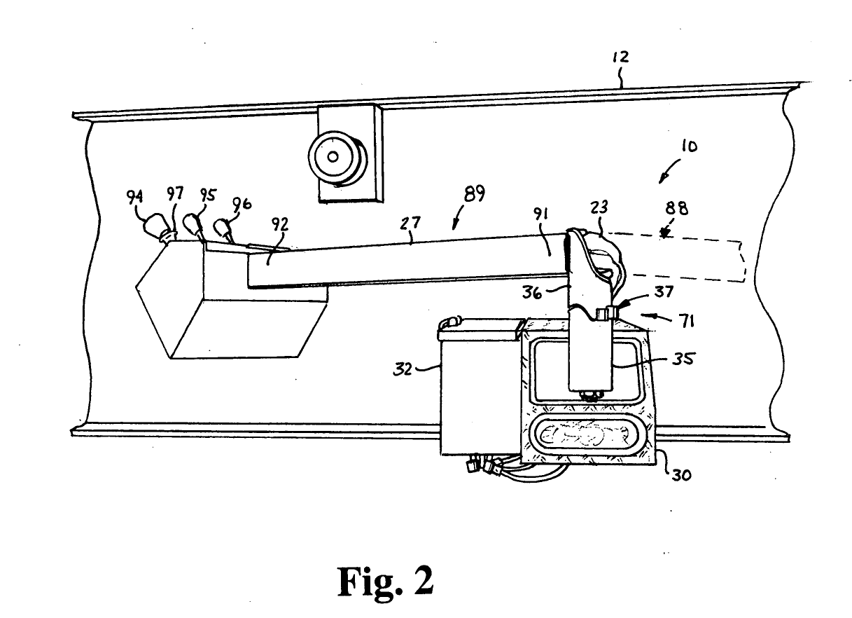

Referring to FIGS. 1-2, there is shown a remotely positionable control system 10 for a container hoist 11. Hoist 11 has a main frame 12 and a hoist frame 13 hingedly connected at a hinge (generally at 15) located at the rear of main frame 12. Hoist 11 further includes various cable winches (not shown). Hoist 11 is operable via lift cylinders (one shown at 16) to pivot hoist frame 13 at hinge 15 between an inclined, container loading position and a horizontal transport position (as shown in FIG. 1). Hoist 11 also includes various hydraulic cylinders and/or other appropriate devices (not shown), to pull a container (not shown) up, onto hoist frame 13, and to move the container to a desired position along the hoist frame 13 and main frame 12 and to offload the container from hoist frame 13. Such hoists and their various components are well know in the industry. Hoist 11 is contemplated to comprise a truck mounted hoist, trailer mounted hoist, or any other vehicle-mounted hoist operable to lift, transport, dump and/or offload one or more containers. In addition, hoist 11 is contemplated to include any appropriate apparatus to grasp, pull, hold and/or offload such container, such as and with limitation, one or more cable and winch assemblies, one or more hook assemblies, and/or one or more slide assemblies, all of which are well known in the industry. Examples of such hoists are shown in U.S. Pat. Nos. 5,088,875 and 5,542,807, which are hereby incorporated by reference. All of the such pivoting hoist frames, winches, cables, hook assemblies, slide assemblies and the like, connected with a container hoist and used to load, shift the position of, transport, dump and/or offload a container, are collectively and individually referred to herein as container manipulating elements.

Control system 10 generally includes an articulating support assembly 21, a control console 22 and signal transfer lines 23. Articulating support assembly 21 includes a first, fixed arm 26, a second, extension arm 27 and a pivot control apparatus 28 that pivotally connects extension arm 27 to fixed arm 26. Fixed arm 26 and extension arm 27 each comprise elongate, metal box tubing, but may be shaped, sized and made of any material desired, so long as the resulting structure reliably withstands the attendant forces and stresses applied thereto. Fixed arm 26 is of a length and is fixedly connected as by welding to main frame 12 at any appropriate place with sufficient space adjacent such point of attachment to permit extension arm 27 to be pivoted alongside main frame 12, as described below. As shown in the cutout of box enclosure 30, a brace plate 31 is fixed as by welding to both fixed arm 26 and main frame 12 to provide additional support for control system 10. Box enclosure 30 generally surrounds fixed arm 26 to protect arm 26, signal transfer lines 23 and any other connections or lines that may be in the area. A utility box 32 is mounted to box enclosure 30 for miscellaneous tools or accessories or can serves as a junction point for the signal transfer lines 23 and any other connections or lines in the area.

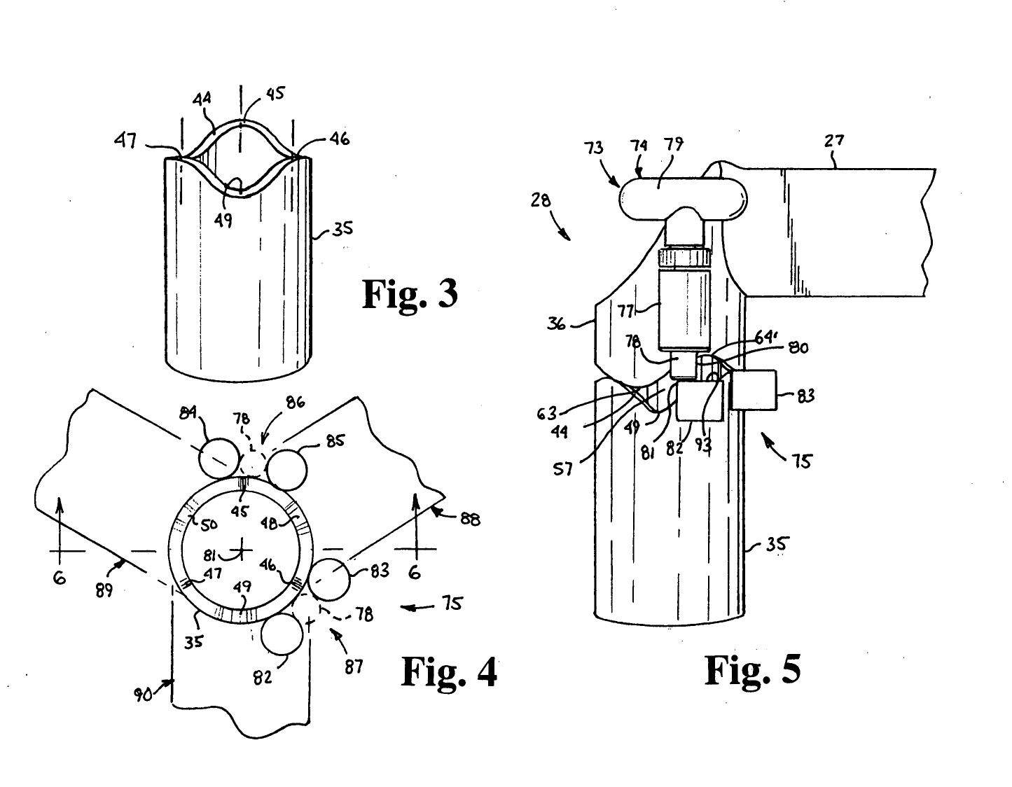

Referring to FIGS. 2-6 pivot control apparatus 28 includes a lower post 35, an upper post 36 and an indexing assembly 37. Lower post 35 includes a cylindrical lower sleeve 39 with an annular anchor disk 40 secured as by welding to its inner surface 41. Anchor disk 40 defines a central hole 42. The top edge or surface 44 of lower sleeve 39 has an undulatory shape to form peaks 45, 46 and 47 that are 60 degrees apart, and to form valleys 48, 49 and 50 that are also 60 degrees apart and equally spaced between peaks 45, 46 and 47. The undulatory shape may be sinusoidal or it may have any other configuration designed to produce a desired pivot behavior of extension arm 27 relative to fixed arm 26.

Upper post 36 includes a cylindrical upper sleeve 53 and an upper anchor disk 54 fixed as by welding to its inner surface 55, and with upper anchor disk 54 having a central hole 56. Upper post 36 also includes a cylindrically shaped axle post 57 telescopically received inside sleeve 53 and is fixed thereto as by welding to the inner surface 55 of sleeve 53. Axle post 57 has an inner wall 58, and an outer wall 59. Outer wall 59 of axle post 57 has substantially the same diameter as inner walls 41 and 55 of lower sleeve 39 and upper sleeve 53, respectively. Axle post 57 extends downwardly beyond the lower surface 62 of sleeve 53 a distance less than lower anchor disk 42 is positioned below upper surface 44 of lower sleeve 39 so that upper sleeve 53 always rests on lower sleeve 39 at surfaces 44 and 62 and with axle post 57 not contacting anchor disc 42. Lower surface 62 of sleeve 53 is undulatory with a shape that is complementary to upper surface 44 of lower sleeve 39, thereby defining peaks (such as at 63) and valleys (such as at 64).

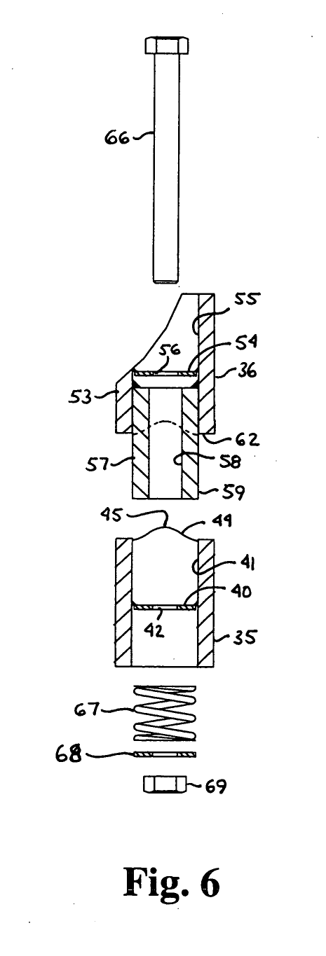

Pivot control apparatus 28 also includes a bolt 66, spring 67, washer 68 and nut 69. In assembly, axle post 57 is received within lower post 35 with upper surface 44 of lower sleeve 39 in contact with lower surface 62 of sleeve 53, and bolt 66 extending down through the hole 56 in anchor disk 54, through axle post 57, and through hole 42 of lower anchor disk 40. The spring 67, washer 68 and nut 69 are received on the lower end of bolt 66 and tightened appropriately to provide a downward bias of upper post 36 against lower post 35. The mating, undulating surfaces 44 and 62 mutually cooperate to provide three mating, rest positions (one, a forward storage rest position shown at 89 in FIG. 2) of upper post 36 relative to lower post 35. Such rest positions are defined by the three peaks (one shown at 63) of upper sleeve 53 being directly aligned with and firmly seated within the three valleys 48, 49 and 50 of lower sleeve 39. Likewise, the three peaks 45, 46 and 47 of lower post 35 are directly aligned with and firmly seated within the three valleys (one shown at 64) of upper sleeve 53. Rotation of upper post 36 from the forward storage rest position 89 will cause upper post 36 to rise, as shown in FIG. 5. In one embodiment, the peaks 45, 46 and 47 of lower post 35 are 0.5 inches higher (in a direction parallel to the axis of lower post 35) than valleys 48, 49 and 50. Likewise, the peaks and valleys of upper sleeve 53 are 0.5 inches apart vertically, which thus provides the 0.5 inch rise of upper post 36. Other embodiments are contemplated wherein the vertical distance between the corresponding peaks and valleys are greater or less than 0.5 inches. Other embodiments also contemplate there being more or fewer peaks or valleys defined in the lower and upper sleeves 39 and 53 to provide additional or fewer indexing positions.

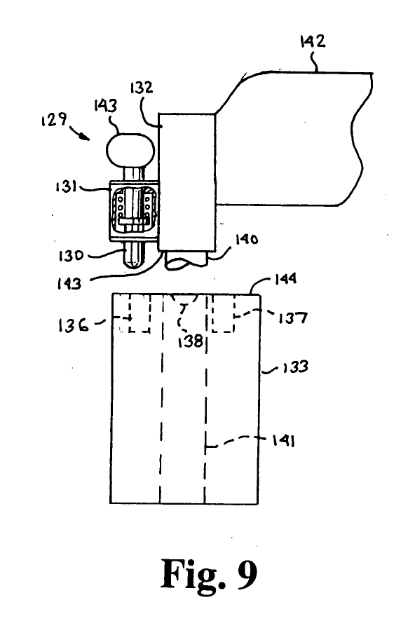

The indexing assembly 37 of pivot control apparatus 28 includes a locking assembly 73 that includes a pin assembly 74 and a cavity apparatus 75. Pin assembly 74 includes a bracket sleeve 77, a pin 78 and handle 79. Bracket sleeve 77 is fixed to the side of upper sleeve 53. At its top, pin 78 is connected to handle 79 and extends downwardly therefrom through sleeve 77. As shown in FIG. 5, pin 78 is biased to its downward-most position, but may be lifted by handle 79 upwardly a short distance, sufficient to clear cavity apparatus 75, as described herein. Bracket sleeve 77 contains a spring mechanism (as shown in the bracket sleeve 131 of the embodiment of FIG. 9) to bias pin assembly 74 to the downward position shown in FIG. 5

Cavity apparatus 75 includes an inner block 82 and an outer block 83, blocks 82 and 83 being fixed as by welding to the outer surface of lower post 35. Blocks 82 and 83 are juxtaposed relative to the outer surface of lower post 35 so that pin 78 can extend downwardly therebetween and be held against movement about the axis 81 of lower post 35, as shown in FIG. 4. Inner block 82 is positioned relative to lower post 35 so that the side 80 of the bottom of pin 78, with pin 78 in its downward position (as shown in FIG. 5), will not contact the side 81 of lower block 82 when upper post 36 is rotated counterclockwise (as viewed in the perspective view of FIG. 5) relative to lower post 35 from the post up position. Instead, pin 78 will move over outer block 82 and, as upper post 36 drops, pin 78 will contact the top surface 93 of outer block 82. Outer block 83 is positioned relative to lower post 35 so that as upper post 36 is rotated counterclockwise (as viewed in FIG. 5) relative to lower post 35, pin 78 in its downward position will contact outer block 83 and prevent further counterclockwise rotation.

While pin assembly 74 (or any similar structure with a movable pin) is connected with upper sleeve 53, and cavity apparatus 75 (or any similar cavity defining structure) is connected with lower sleeve 39, alternative embodiments are contemplated wherein the pin containing structure is connected with lower sleeve 39 and the cavity defining structure is connected with the other of the two sleeves, which here is upper sleeve 53.

In operation, from the post up position whereby peak 63 of upper post 36 and peak 47 of lower post 35 are substantially aligned, counterclockwise rotation of upper post 36 (that is, bracket sleeve 77 moving from left to right as seen in FIG. 5) will result in upper post 36 dropping as peak 63 travels down surface 44 to valley 49. As upper post 36 falls, pin 78 will move slightly over inner block 82. As upper post 36 continues to rotate counterclockwise and peak 63 drops into valley 49, the bottom of pin 78, now somewhat above block 82, will contact the top 93 of block 82, and pin 78 will be pushed upwardly against the bias of the spring (not shown) contained within bracket sleeve 77. As upper post 36 continues to rotate counterclockwise, peak 63 will align with valley 49 at which point pin 78 will clear inner block 82 and will drop into the gap between blocks 82 and 83, thereby locking upper post 36 in this, a control system transport position, whereby extension arm 27 and its control console 22 will stay securely positioned proximal to the side of mainframe 12. Another set of blocks (inner block 84 and outer block 85) are securely fixed to lower post 35 at a position 120 degrees clockwise from blocks 82 and 83 as viewed in FIG. 4. That is, inner and outer blocks 84 and 85 are secured to lower post 35 to provide a locking position for pin 78, such locking position 86 being located 120 degrees from the locking position 87 defined by blocks 82 and 83. Thus, control assembly 10 may be locked in a rear storage rest position (shown at 88 in FIG. 2) and characterized by extension arm 27 and control console 22 extended rearwardly, or a forward storage rest position 89 characterized by extension arm 27 and control console 22 facing forwardly. From either storage rest position, extension arm 27 and upper post 36 may be pivoted by first pulling upwardly on handle 79 to lift pin 78 out of the respective locking positions 86 or 87, and then rotating extension arm 27 and upper post 36. There will, of course, be some bias against such pivoting as the undulating surfaces 44 and 62 will cause upper post 36 and extension arm 27 to rise. Because undulating surfaces 44 and 62 each define three peaks and three valleys, there are three indexed positions, one corresponding to rear storage rest position 88 and one corresponding to forward storage rest position 89. The third indexed position is the use rest position 90, which is characterized by extension arm 27 extending essentially 90 degrees to the side from mainframe 12 and 60 degrees from either the rear storage rest position 88 or forward storage rest position 89.

Extension arm 27 is securely fixed at its inboard end 91 to upper post 36 by any appropriate means such as welding, as shown in FIG. 2. Control console 22 is securely fixed, by any appropriate means such as welding, to the outboard end 92 of extension arm 27. Control console 22 is provided with a desired set of user control elements, such as joysticks 94, 95 and 96 and/or switches (such as at 97), to control desired container manipulating elements of container hoist 11. For example, joystick 94 could be connected via the signal transfer lines 23 to control the lift cylinders (one shown at 16) that raise and lower hoist frame 13. Control console 22 is contemplated to comprise any appropriate unit or structural configuration having at least one user control element and connected to the outboard end 92 of extension arm 27. The signal transfer lines 23 extend from control console 22, through extension arm 27, into first arm 26 and into main frame 12 (or to utility box 32) and to the appropriate container manipulating elements and/or their various activating elements (circuit boxes, hydraulic control junctions, and the like).

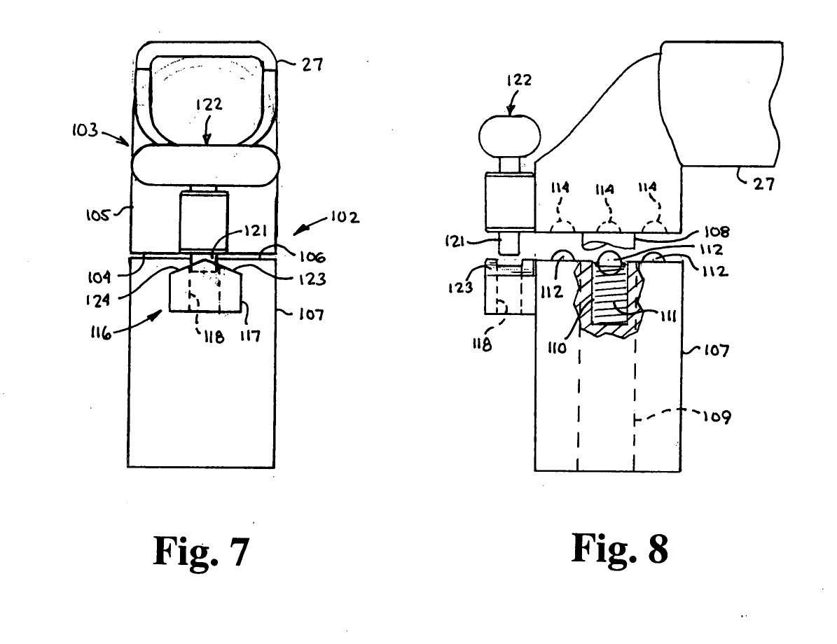

Referring to FIGS. 7 and 8 there is shown an indexing assembly 102 and a locking assembly 103 in accordance with another embodiment of the present invention. Indexing assembly 102 includes lower surface 104 of upper post 105 and upper surface 106 of lower post 107 being flat, which permits otherwise uninhibited free rotation between upper and lower posts 105 and 107. Upper post 105 has a downwardly extending axle post 108 that extends into a central hole 109 defined in lower post 107, and upper post 105 is thus supported for rotation upon lower post 107 via axle post 108. Lower post 107 is provided with three cavities (one shown at 110), each of which holds a spring 111 and detent ball 112 (collectively, a detent element). Upper post 105 defines three detent cavities 114 which are 60 degrees apart and correspond with the three spring-loaded detent balls 112. Upper post 105 can thus rotate with respect to lower post 107 and be releasably locked in position relative to lower post 107 in three positions, 60 degrees apart. Alternative embodiments are contemplated where there are more or fewer than three spring-loaded detent balls 112 and/or more or fewer than three detent cavities 114 defined in upper post 105 at any one or more desired locations, such arrangement thus providing any one or more desired indexing location of upper post 105 relative to lower post 107. For example, there may be just one spring-loaded ball 112 in lower post 107 and one, two or more detent cavities 114 defined in upper post 105. Or, there may be two balls and three cavities, for example. Alternative embodiments are contemplated wherein the ball(s) 112 are loaded in the upper post 105 and the cavity or cavities 114 are defined in the lower post 107.

The locking assembly 103 of the embodiment of FIGS. 7 and 8 is similar to locking assembly 73 of FIG. 5, except that cavity apparatus 116 comprises a block 117 with a central hole 118 sized to receive the pin 121 of pin assembly 122. Block 117 defines opposing, sloped upper surfaces 123 and 124. As upper post 105 is rotated toward block 117, pin 121 engages the respective upper surface 123 or 124, which urges pin 121 upwardly against the bias of the spring (not shown) of spring assembly 122. When pin 121 clears the respective sloped surface and aligns with hole 118, it drops down into hole 118, thereby locking upper post 105 in position, as shown in FIG. 7. Locking assembly 103 is shown with just a single cavity apparatus 116 corresponding to a rear storage rest position, but a second cavity apparatus 116 is contemplated to be mounted in a position to provide a forward storage rest position, if desired.

Referring to FIG. 9, there is shown a combined indexing and locking mechanism in accordance with another embodiment of the present invention. Like the pins 78 of FIG. 5 and 121 of FIG. 8, pin 130 is spring biased downwardly and is contained within a bracket sleeve 131 that is fixed to the side of upper post 132. The diameter of upper post 132 is considerably smaller than the diameter of lower post 133 so that pin 131 is alignable with two locking cavities 136 and 137 and a detent cavity 138, the cavities 136, 137 and 138 being defined in lower post 133. An axle post 140 of upper post 132 extends downwardly into a central hole 141 of lower post 133 to provide the axis of rotation for upper post 132 (and its extension arm 142). The diameter of axle post 140 is approximately equal to the diameter of hole 141 and is sufficiently smaller than the diameter of upper post 132 (from which axle post 140 extends) to create a support ledge 143, which rests on the top surface 144 of lower post 133, thus supporting upper post 132 for rotation on lower post 133. In operation upper post 132 and its extension arm 142 can be rotated relative to lower post 133 until pin 130 aligns with either locking cavity 136 or locking cavity 137, whereby pin 130 drops into such locking cavity to lock post 132 and extension arm 142 in place. Locking cavities 136 and 137 are thus defined in lower post 133 in positions to lock the extension arm 142 in the desired transport position. In one embodiment, cavities 136 and 137 and detent cavity 138 are 120 degrees apart, but these positions may be selected to provide any desired rest (transport) position for the extension arm 142. The extension arm 142 and post 132 can be rotated away from such transport position by pulling up on handle 143 to pull pin 130 out of the corresponding locking cavity 136 or 137. Detent cavity 138 is defined in lower post 133 so that when extension arm 142 is in the use position (extending approximately 90 degrees outwardly from the container mainframe 12) pin 130 will drop down into detent cavity 138 to temporarily lock extension arm 142 in such use position.

As with the other use positions described herein, rather than requiring the user to reach over and lift handle 143 (or handle 79 of the embodiment of FIG. 5), the user simply needs to push the extension arm 142 one direction or the other to dislodge pin 130 from its detent cavity 138. The embodiments described herein are all preferably and similarly configured to enable the user to move console system 10 from the use position merely by manually urging it one way or another, but also to have a positively locked, transport position that requires physically changing a locked condition at a locking mechanism, such as locking assembly 73, to move control system 10 from such transport position.

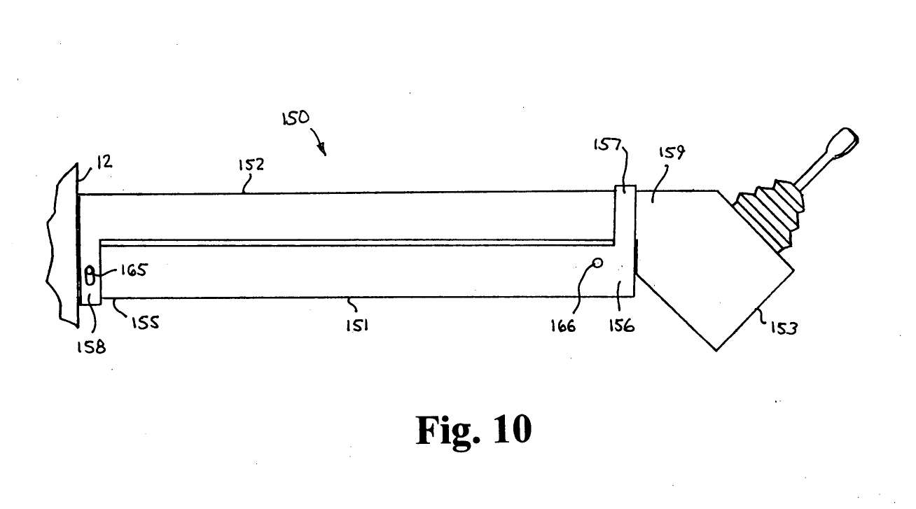

Referring to FIG. 10 there is shown a remotely positionable control system 150 in accordance with another embodiment of the present invention. Control system 150 includes a fixed arm 151, an extension arm 152 and a control console 153. At its inboard end 155, fixed arm 151 is fixedly connected as by welding to the vehicle mainframe 12. At its outboard end 156, fixed arm 151 includes an upwardly extending sleeve 157 through which slidably extends extension arm 152. At its inboard end, extension arm 152 defines a downwardly extending sleeve 158 through which slidably extends fixed arm 151. At the outboard end 159 of extension arm 152 is fixedly connected the control console 153. An appropriate locking mechanism is provided to lock control system 150 in the transport position (as shown in FIG. 10). Such lock mechanism may be any appropriate device for positively locking control system 10 in the position shown in FIG. 10 and may include a spring biased pin 165 that is connected to sleeve 158 and is spring biased into a locking cavity (not shown) defined at the inboard end 155 of fixed arm 151. Such locking pin assembly would be similar to the pin assembly 74 shown in FIG. 5 and would be connected, for example, to sleeve 158, and the locking cavity would be a hole defined in arm 151 and aligned with the pin in the desired locking position. The outboard end of fixed arm 151 would define a detent cavity 166 (like cavity 138 of FIG. 9) that would engage with pin 165 when extension arm 152 is extended outwardly (to the right as shown in FIG. 10) and would temporarily hold extension arm 152 and console 153 in the extended position (not shown). In operation, pin 165 can be pulled and unlatched, and extension arm 152 in console 153 can be pulled away from mainframe 12 (to the right as viewed in FIG. 10) until pin 165 engages with detent cavity 166 for use (the use position). Extension arm 152 and console 153 can be simply be pushed toward main frame 12 to return control system 150 to its storage rest position (FIG. 10)

Alternative embodiments are contemplated wherein fixed arm 26 (or fixed arm 151) is pivotally mounted to main frame 12 via a hinge mechanism that permits some (e.g. a few degrees) or a great deal (e.g. 180 degrees) of pivotal movement of arm 26 relative to main frame 12. Such hinge mechanism is also contemplated to include some form of pivot control apparatus that may be very similar to the pivot control apparatuses described herein.

The embodiments of the remotely positionable control systems of FIGS. 1-10 disclose a first arm connected to the vehicle and a second arm pivotably or slidably (movably) connected to the first arm to move between a storage, rest (transport) position and an extended, use position, the control console being connected to the outboard end of the second arm. Alternative embodiments are contemplated wherein a remotely positionable control system has the same first and second arms and, in addition, has a third arm pivotably or slidably (movably) connected to the outboard end of the second arm to move between the storage, rest (transport) position and the extended, use position, the control console being connected to the outboard end of the third arm. In such embodiment, the first, second and third arms could all be pivotally connected together (such as disclosed in the embodiments of FIGS. 1-9), could all be slidably connected together (such as disclosed in the embodiment of FIG. 10) or could be connected together with a combination of pivoting and sliding connections. Alternative embodiments are also contemplated wherein there are more than three arms interconnected by some combination of pivoting and sliding connections.

Upper post 36 is described as having an upper sleeve 53 with an axle post 57 connected thereto. Alternative embodiments contemplate upper post comprising a single, integrally form element with an axle post extending downwardly therefrom into a hole defined in lower post 35, or lower post 35 having an axle post that extends up into a central hole defined in upper post 36.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A remotely positionable control system for use with a container hoist vehicle having a main frame and container manipulating elements, comprising:
an articulating support assembly having first and second arms each having inboard and outboard ends, the first arm being connectable at its inboard end to the main frame of a hoist vehicle and the second arm being movably connected at its inboard end to the outboard end of the first arm to move between a storage rest position and an extended use position;
a control console mounted to the outboard end of the second arm and having at least one user control element;
signal transfer means for operationally connecting the at least one user control element with the container manipulating elements; and,
a control apparatus for releasably holding the second arm in at least one of the storage rest position and the extended use position.

2. The remotely positionable control system of claim 1 wherein the second arm is pivotally connected at its inboard end to the outboard end of the first arm.

3. The remotely positionable control system of claim 2 wherein said control apparatus is a pivot control apparatus and includes a first post connected to the first arm, a second post connected to the second arm and an indexing assembly connected with the first and second posts for releasably holding the second arm in a desired angular position relative to the first arm.

4. The remotely positionable control system of claim 3 wherein the pivot control apparatus includes the second post being coaxially, rotatably connected to the first post.

5. The remotely positionable control system of claim 4 wherein the first post includes a lower sleeve and the second post includes an upper sleeve coaxially sitting above the lower sleeve.

6. The remotely positionable control system of claim 5 wherein the lower sleeve defines an upper surface having a first undulatory shape, wherein the upper sleeve defines a lower surface having a second undulatory shape, and wherein the second surface operationally engages with the first surface to cause the second post and second arm to rise and fall as the second post rotates relative to the first post.

7. The remotely positionable control system of claim 6 wherein the first and second undulatory shapes are generally sinusoidal.

8. The remotely positionable control system of claim 6 wherein the first and second undulatory shapes each define three peaks and three valleys.

9. The remotely positionable control system of claim 8 wherein the peaks of the first undulatory surface are approximately 0.5 inches above the valleys of the first undulatory surface.

10. The remotely positionable control system of claim 3 wherein the indexing assembly includes at least one pin assembly and at least one cavity apparatus, the at least one cavity apparatus connected with one of the first and second posts and defining at least one cavity, and the pin assembly connected with the other of the first and second posts and including at least one pin engagable with the at least one cavity to removably hold the second arm in a desired angular position relative to the first arm.

11. The remotely positionable control system of claim 10 wherein the first post is a lower post and includes a lower sleeve with an upper surface having an upper undulating shape and the second post is an upper post including an upper sleeve with a lower surface having a lower undulating shape that is complementary to the upper undulating shape.

12. The remotely positionable control system of claim 11 wherein the pin assembly includes a pin mounted to the upper post to move between a down, rest position and an up, release position.

13. The remotely positionable control system of claim 12 wherein the pin is spring biased to the down, rest position.

14. The remotely positionable control system of claim 12 wherein the at least one cavity apparatus is connected with the lower post and defines a top surface proximal to the at least one cavity.

15. The remotely positionable control system of claim 14 wherein the upper sleeve rides atop the lower sleeve and the undulating lower surface engages with the undulating upper surface to cause the upper post to rise and fall as it rotates relative to the lower post, and wherein the top surface of the at least one cavity apparatus is juxtaposed relative to the pin apparatus so that the pin, in its down, rest position, slides across the top surface and into the at least one cavity as the second post is rotated relative to the first post.

16. The remotely positionable control system of claim 15 wherein the at least one cavity apparatus includes a first cavity apparatus and a second cavity apparatus that is juxtaposed approximately 120 degrees from the first cavity apparatus.

17. The remotely positionable control system of claim 16 wherein the undulating upper and lower shapes are generally sinusoidal and the extended use position includes the second arm extending away from the inboard end of the first arm.

18. The remotely positionable control system of claim 10 wherein the at least one cavity apparatus includes a block defining a hole and connected to the first post and the pin assembly includes a pin mounted to the second post to move between a down, rest position releasably extending into the block hole and an up, release position clear of the block hole.

19. The remotely positionable control system of claim 3 wherein the first post is a lower post and includes an upper surface and the second post is an upper post with a lower surface, and wherein the indexing assembly includes at least one cavity defined in one of the upper and lower surfaces and includes at least one detent element held by the other of the upper and lower surfaces and positioned to engage with the at least one cavity and releasably hold the upper post against rotation relative to the lower post.

20. The remotely positionable control system of claim 19 wherein the upper and lower surfaces are substantially flat and there are three of the at least one cavities defined in the upper surface.

21. The remotely positionable control system of claim 19 wherein the indexing assembly includes a pin assembly connected with the upper post and including a pin movable to engage with the at least one cavity to releasably lock the upper post in the storage rest position.

22. The remotely positionable control system of claim 1 wherein the storage rest position includes said control console being located proximal to the main frame of the hoist and the extended use position includes said control console being located distal from the main frame of the hoist vehicle.

23. The remotely positionable control system of claim 1 wherein the second arm is slidably connected to the first arm.

24. The remotely positionable control system of claim 23 wherein the first arm includes a first sleeve through which slidably extends the second arm, and the second arm includes a second sleeve through which slidably extends the first arm.

25. The remotely positionable control system of claim 24 wherein said control apparatus includes a hole defined in one of the first arm and second arm and includes a pin connected with the other of the first arm and second arm, the pin being engagable with the hole to removably lock the second arm in the storage rest position.

26. A method for controlling container manipulating elements of a vehicle mounted container hoist, comprising the steps of:
providing a container hoist with a main frame and at least one container manipulating element;
providing a remotely positionable control system including an articulating support assembly having first and second arms each having inboard and outboard ends, the first arm being connected at its inboard end to the main frame and the second arm being movably connected at its inboard end to the outboard end of the first arm to move between a storage rest position and an extended use position; a control console mounted to the outboard end of the second arm and having at least one user control element; signal transfer means for operationally connecting the at least one user control element with the at least one container manipulating element; and, a control apparatus for releasably holding the second arm in at least one of the storage rest position and the extended use position;
moving the second arm relative to the first arm until the control apparatus releasably locks the second arm in the storage rest position.

27. The method for controlling container manipulating elements of a vehicle of claim 26 wherein the providing a remotely positionable control system step includes the second arm being pivotally connected at its inboard end to the outboard end of the first arm.

28. The method for controlling container manipulating elements of a vehicle of claim 27 wherein the providing a remotely positionable control system step includes the control apparatus being a pivot control apparatus and includes a first post connected to the first arm, a second post connected to the second arm and an indexing assembly connected with the first and second posts for releasably holding the second arm in a desired angular position relative to the first arm.

29. A remotely positionable control system for use with a container hoist vehicle having a main frame and container manipulating elements, comprising:
an articulating support assembly having first and second arms each having inboard and outboard ends, the first arm being connectable at its inboard end to the main frame of a hoist vehicle and the second arm being rotatably connected at its inboard end to the outboard end of the first arm to move between a storage rest position and an extended use position;
a control console mounted to the outboard end of the second arm and having at least one user control element; signal transfer means for operationally connecting the at least one user control element with the container manipulating elements; and,
a control apparatus connected at the inboard end of the second arm and the outboard end of the first arm to bias the second arm to remain in the extended use position.

30. The remotely positionable control system of claim 29 wherein said control apparatus includes a lower post connected with the first arm and having an upper undulating surface and includes an upper post connected with the second arm and having a lower undulating surface that mates with and rides atop the upper undulating.

31. The remotely positionable control system of claim 30 wherein said control apparatus includes an indexing mechanism connected with the upper and lower posts for releasably holding the second arm in a desired angular position relative to the first arm.

32. The remotely positionable control system of claim 31 wherein the indexing mechanism includes at least one pin assembly and at least one cavity apparatus, the at least one cavity apparatus connected with one of the upper and lower posts and defining at least one cavity, and the pin assembly connected with the other of the upper and lower posts and including at least one pin engagable with the at least one cavity to removably hold the second arm in a desired angular position relative to the first arm.
